(19) United States
(12) Patent Application Publication
(10) Pub. No.: US 2008/0165776 A1
(43) Pub. Date: Jul. 10, 2008

(54) Relay Tunneling in Wireless Multi-User Multi-Hop Relay Networks

(76) Inventors: Zhifeng Tao, Allston, MA (US); Toshiyuki Kuze, Kanagawa (JP); Jinyun Zhang, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/620,947

(22) Filed: Jan. 8, 2007

(51) Int. Cl. H04L 12/56

(52) U.S. Cl. 370/392

(57) ABSTRACT

A method communicates packets in a relay network. The packets are communicated from a set of mobile stations to a relay station using a set of connections, there being one connection between each mobile station and the relay station. The packets are communicated between the relay station and a base station using a relay tunnel connection, between the relay station and its adjacent relay station the packets are communicated using the relay tunnel connection.

### FIELD OF THE INVENTION

This invention relates generally to wireless multi-user mobile networks, and more particularly to relay tunneling in a wireless mobile multi-user, multi-hop networks.

### BACKGROUND OF THE INVENTION

IEEE Standards

The following standard specifications are incorporated herein by reference:

“IEEE 802.16j Mobile Multihop Relay Project Authorization Request (PAR),” Official IEEE 802.16j, March 2006, “IEEE Standard for Local and Metropolitan Area Networks—Part 16: Air Interface for Fixed Broadband Wireless Access Systems,” IEEE Computer Society and the IEEE Microwave Theory and Techniques Society, October 2004, and “IEEE Standard for Local and Metropolitan Area Networks—Part 16: Air Interface for Fixed Broadband Wireless Access Systems, Amendment 2: Physical and Medium Access Control Layers for Combined Fixed and Mobile Operation in Licensed Bands,” IEEE Computer Society and the IEEE Microwave Theory and Techniques Society, February 2006.

OFDM

Orthogonal frequency-division multiplexing (OFDM) is a modulation technique used at the physical layer (PHY) of a number of wireless networks, e.g., networks designed according to the IEEE 802.11a/g, and IEEE 802.16/16e standards.

OFDMA

OFDMA is a multiple access scheme based on OFDM. In OFDMA, separate sets of orthogonal tones (subchannels) and time slots are allocated to multiple transceivers (users) so that the transceivers can communicate concurrently. As an example, the IEEE 802.16/16e standard, has adopted OFDMA as the multiple channel access mechanism for non-line-of sight (NLOS) communications at frequencies below 11 GHz.

FIG. 1A shows a conventional OFDMA-based cellular network 100, e.g., a wireless network according to the IEEE 802.16/16e standard. The network operates in a point-to-multipoint topology, wherein only two types of network entity exist, namely base stations (BS), and mobile stations (MS). The BS manages and coordinates all communications with the MS in a particular cell on connections 101-103. Each MS is in direct communication with only the BS, and only the BS communicates with an infrastructure 110 or “backbone” of the network. That is, there is only one hop between the MS and the BS. All communications between the MS must pass through the BS. Furthermore, there is one connection between the BS and each MS.

Due to significant loss of signal strength along the connection for certain spectrum, the coverage area of wireless service is often of limited geographical size. In addition, blocking and random fading frequently results in areas of poor reception, or even dead spots. Conventionally, this problem has been addressed by deploying BSs in a denser manner. However, the high cost of BSs and potential increase in interference, among others, render this approach less desirable.

As shown in FIG. 1B for an alternative approach, a relay-based network 150 can be used. The network includes multiple mobile stations (MS) and/or subscriber stations (SS). A relatively low-cost relay station RS extends the range of the BS. Some of the stations (MS1 and SS1) communicate directly with the BS using connections C1 and C2. Other stations (MS2, MS3 and SS2) communicate directly with the RS using connections C3, C4 and C5, and indirectly with the BS via corresponding connections 151 using two hops.

Obviously, a notion of traffic aggregation occurs on the relay link (i.e., the link between the RS and BS, and the link between a pair of adjacent RSs). To simplify the traffic management and improve system performance, the traffic aggregation should be handled properly.

### SUMMARY OF THE INVENTION

A method communicates packets in a relay network. The packets are communicated from a set of mobile stations to a relay station using a set of connections, there being one connection between each mobile station and the relay station. The packets are communicated between the relay station and a base station using a relay tennel connection, between the relay station and its adjacent relay station the packets are communicated using the relay tunnel connection.

### BRIEF DESCRIPTION OF THE DRAWINGS

FIG. 1A is a schematic of a prior art wireless mobile networks;

FIG. 1B is a schematic of a prior art wireless mobile relay network;

FIG. 2 is a schematic of a wireless mobile relay network according to an embodiment of the invention;

FIG. 3 is a schematic of a wireless mobile relay network and relay tunnel according to wan embodiment of the invention;

FIG. 4 is a block diagram of a tunnel function for relay tunnels according to the invention; and

FIG. 5 is a block diagram of mapping from MAC connections to relay tunnel connection, and subsequently to HARQ channels according to an embodiment of the invention.

### DETAILED DESCRIPTION OF THE PREFERRED EMBODIMENTS

Definitions

For the sake of clarify and description of the invention the following terms are defined and used accordingly herein.

Base Station

Equipment to provide wireless communication between subscriber equipment and an infrastructure or network backbone.

Subscriber Station (SS)

A generalized equipment set to provide communication between the subscriber equipment and the base station (BS).

Mobile Station (MS)

A wireless transceiver intended to be used while in motion or at unspecified locations. The MS is always a subscriber station (SS) unless specifically specified otherwise.

Relay Station (RS)

A wireless transceiver whose function is to relay data and control information between other stations and to execute processes that support multi-hop communications.

Relay Link

A relay link is the wireless link directly connecting a BS and a RS, or between two adjacent RSs.

Connection

At a physical layer, a connection runs from an RF transmitter of a station via one or more transmit antennas through a wireless channel to an RF receiver of another station via one or more receive antennas. Physically, the connection communicates RF signals using a predetermined set of subchannels and time slots. At a logical layer, the portion of interest of the connection runs from a media access layer (MAC) of a protocol stack in the transmitter to the media access layer in the receiver. Logically, the connection caries the data and control information as a single bit stream.

MAC Service Data Unit (MSDU)

A set of data specified in a protocol of a given layer and consisting of protocol control information of that layer, and possibly user data of that layer.

MAC Protocol Data Unit (MPDU)

A protocol data unit of a given layer of a protocol including the service data unit coming from a higher layer and the protocol control information of that layer.

All other conventional acronyms used herein are define in the above IEEE standards, see also “Harmonized definitions and terminology for 802.16j Mobile Multihop Relay,” IEEE 802.16j-06/14r1, October 2006, and W. Stallings, “Data and Computer Communications,” Seventh edition, Prentice Hall, 2003, both incorporated herein by reference.

Network Structure

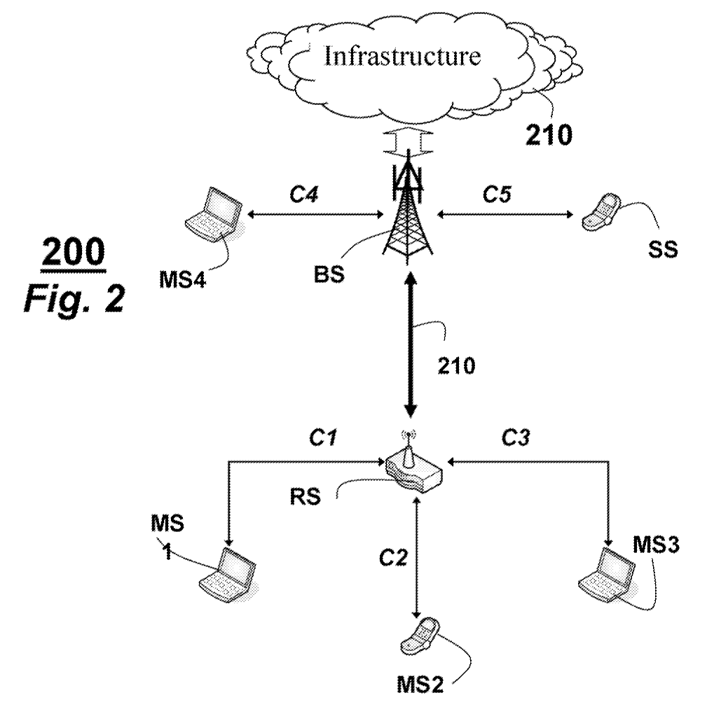

As shown in FIG. 2 for one embodiment of the invention, a network 200 communicates packets from a set of mobile stations (MS) to a relay station (RS) using a set of connections (C1, C2, C3). There is one connection between each mobile station and the relay station. The relay station and a base station (BS) using a single connection 210 to communicate the packets. The BS can also communicate with other MS and SS using direct connections C4 and C5. The BS can communicate with an infrastructure 210.

According to the IEEE 802.16 standard, there is a unidirectional mapping established and maintained between the BS and the MS/SS medium access control (MAC) layers for the purpose of communicating a service flow bit stream (traffic). All traffic is carried on connections, even if the service flows is implemented with a connectionless protocol, e.g., IP.

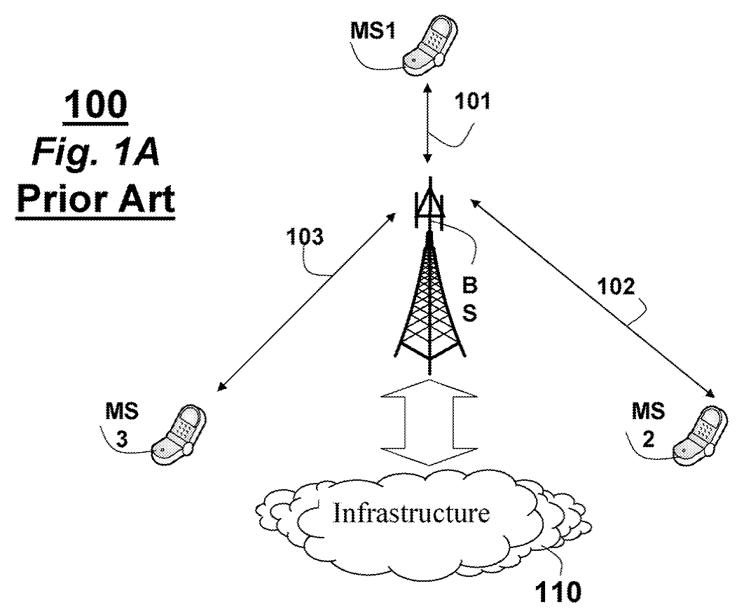

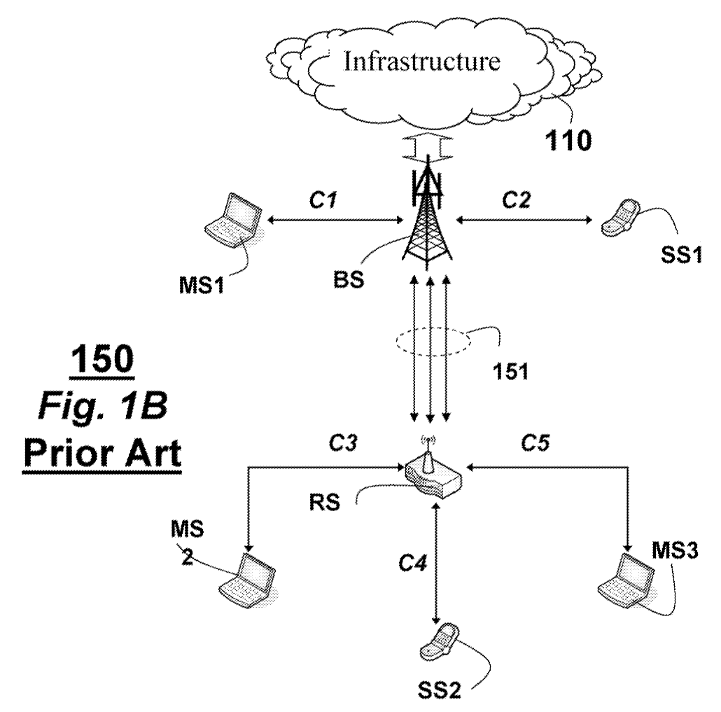

In the conventional point-to-multipoint (PMP) network as shown in FIG. 1A, resource allocation is performed by BS on a per connection basis, and all the MSs are treated substantially equally. This makes sense for moderately sized, single-hop PMP network.

However, as traffic collected from and distributed to the multitude of SS/MSs tends to aggregate on the relay links, a tunneling approach is a natural solution to use.

Relay Tunneling Concept

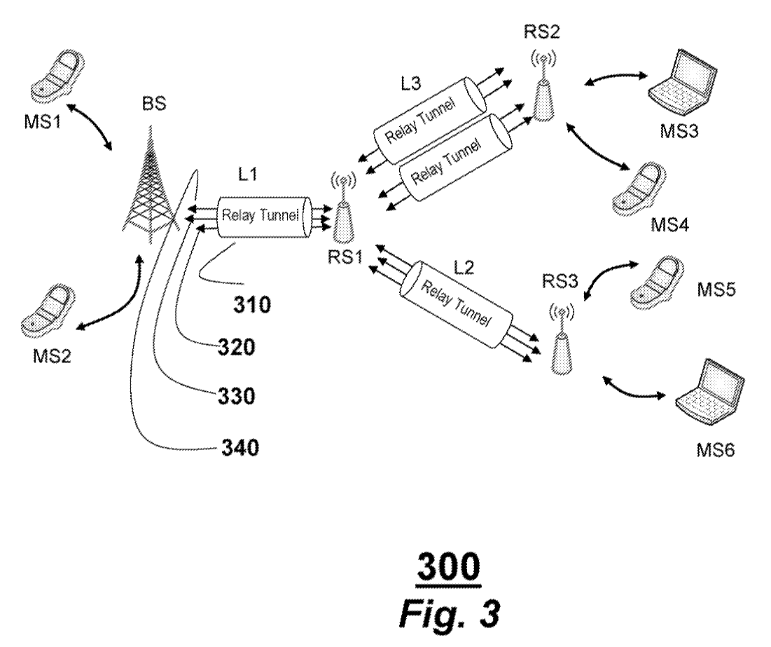

As shown in FIG. 3, relay tunnels (L1-L3) are unidirectional logical connections that can be established on a per link basis on relay link between a base station (BS) and a relay station (RS), or between relay stations. One or multiple IEEE 802.16e MAC level connections, e.g., 320, 330, 340 in FIG. 3, that meet certain criteria, e.g., sharing the same quality of service requirement, can be logically grouped together into a relay tunnel, e.g., 310 in FIG. 3. Apparently, more that one relay tunnels can be created on each relay link, as traffic of widely diverse characteristics and requirements may exist on the relay link.

Given the unidirectional nature of the relay tunnel, two separate tunnels shall be created in each direction for a bi-directional traffic stream.

Note that the conventional MAC connection is an end-to-end connection between the BS and SS/MS, while relay tunnel connection is a link-by-link tunnel connection.

Relay Tunnel Identification

A relay tunnel connection identified (R-CID) is used to uniquely identify the relay tunnel, and distinguish it from the conventional MAC connection and end-to-end tunnel connection.

Accordingly, Table 345 in the IEEE 802.16e-2005 standard is revised to incorporate the relay tunnel CID as shown in Table 1 in italics.

TABLE 1

| CID | Value | Description |
|---|---|---|
| . . . | | |
| Primary | m + 1 − 2m | |
| management | | |
| Relay tunnel CID | 2m + 1 − n | Used by MMR-BS or RS for relay |
| | | packets. |
| Transport CIDs, | n + 1-FE9F | For the secondary management |
| Secondary Mgt | | connection, the same value is assigned |
| CIDs | | to both the DL and UL connection. |
| . . . | | |

Relay Tunnel MAC PDU Construction

To construct a relay tunnel MAC PDU, all the MAC PDUs from the individual constituent MAC connection can be concatenated together to be a single transmission burst. As an alternative, a relay tunnel MAC header can be appended in front of the MAC concatenation. If the second approach is used, the relay tunnel connection CID is be used in the relay tunnel MAC header.

Relay Tunnel Creation, Termination and Lifespan

The relay tunnel connection is established by using the dynamic service addition request (DSA-REQ) and response (SDA-RSP) message defined in the current IEEE 802.16e standard. A relay tunnel exists after being established, regardless of whether there is any traffic flowing. New MAC connection can also be added into an existing relay tunnel, if proper requirement, e.g., quality of service, bandwith, etc., can be met.

In fact, even if all the current constituent MAC connections have been terminated, the corresponding relay tunnel remain active, because new MAC connections may join the tunnel in the future. A relay tunnel is only terminated, if the originating BS or RS is powered off. Therefore, relay tunnel connection is a semi-permanent logical connection.

The decision of whether to establish a relay tunnel, and which MAC connection should be included into which relay tunnel, is total under the discretion of the BS or RS from which the traffic is transmitted.

After the relay tunnel is created, MAC PDUs that belong to each individual constituent MAC connection will be transported in the corresponding relay tunnel.

Traffic Management Using Relay Tunnel Connection

The quality of service (QoS) control and traffic management can be significantly simplified, when they are managed on a per relay tunnel basis. Instead of dealing with a large number of MAC connections, the MAC, e.g., bandwidth request subheader and grant management subheader in the IEEE 802.16e standard, now only needs to handle a far less number of relay tunnel connections for traffic policing and QoS assurance.

Routing Management with Relay Tunnel Connection

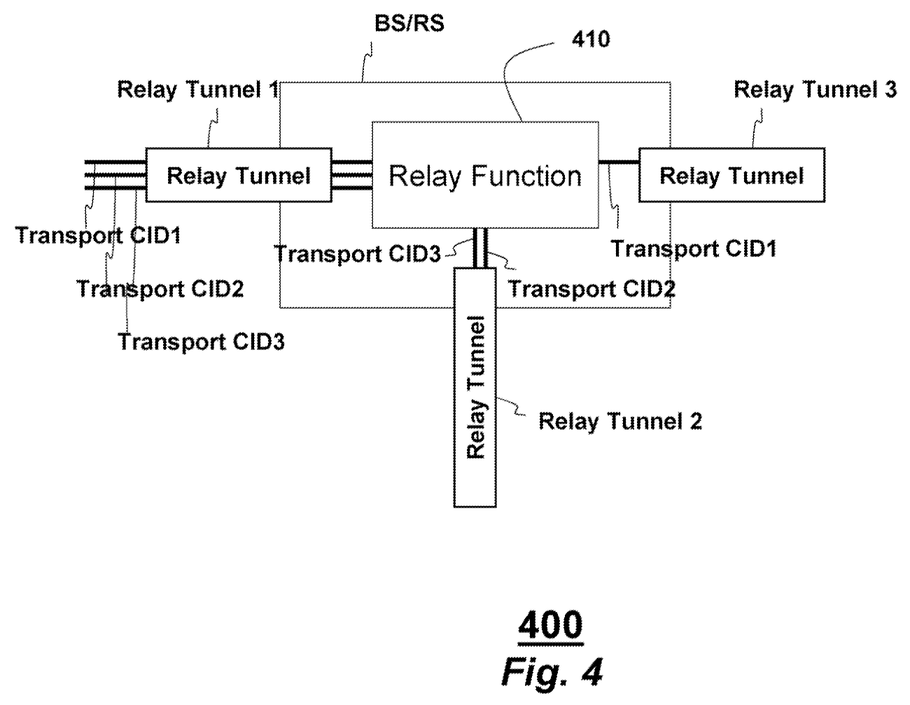

As shown in FIG. 4, the BS and RS, which are end points of the relay tunnel, has the full information with regard to the mapping between individual MAC connection, e.g., transport CID, and the relay tunnel. The relaying function 41o at the BS and RS can relay traffic on a per relay tunnel connection basis. The relaying function can also retrieve the MAC PDUs from the incoming tunnel connection, and determine where the MAC PDUs shall be sent to and through which outgoing relay tunnel they should be sent, based upon the CID of each MAC PDU. This is shown in FIG. 4.

Relay tunnel connection also makes it easier to handle the handover of mobile relay station, as the handover only need to be applied on a small number of relay tunnel connections, rather than a large number of individual MAC connection or end-to-end tunnel connection.

Relay Tunnel Connection with HARQ

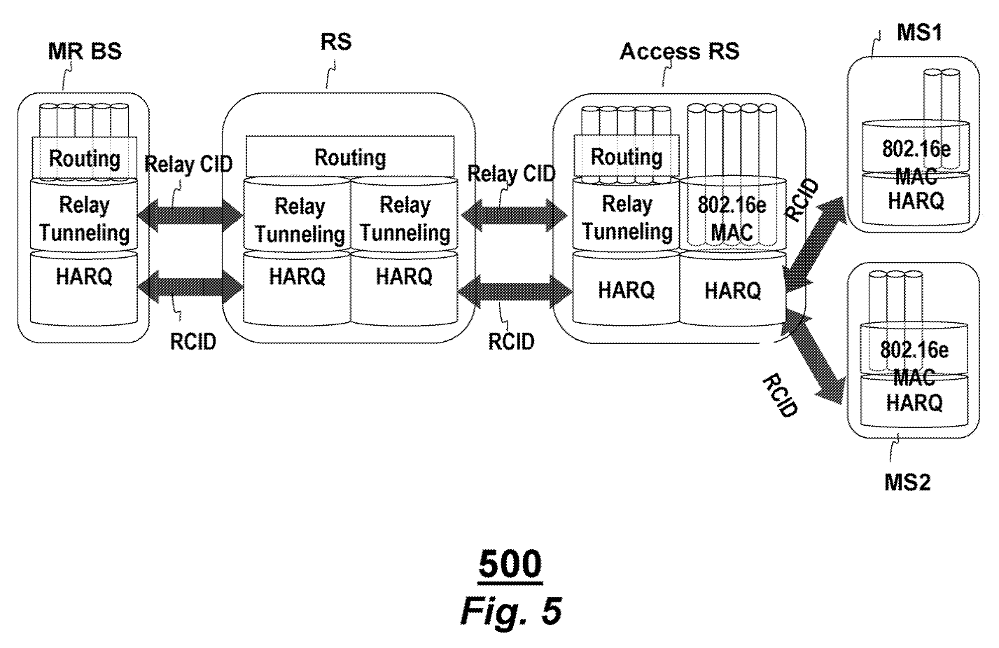

If relay tunnel connection is used in conjunction with HARQ, a proper form of the relay tunnel CID shall be used in the reduced CID (RCID) field for HARQ. FIG. 5 shows the mapping from MAC connections to relay tunnel connection, and subsequently to HARQ channels.

In addition, if multiple HARQ channels will be used to transport MAC PDUs of one relay tunnel connection, relay tunnel MAC PDU shall include the relay tunnel MAC header. Moreover, a PDU sequence number (SN) extended subheader shall be inserted immediately after the relay tunnel MAC header to avoid potential out-of-order data delivery problem.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for communicating packets in a relay network, comprising:
communicating a plurality of packets from a set of mobile stations to a relay station using a set of connections, there being one connection between each mobile station and the relay station;
communicating the plurality of packets between the relay station and a base station using a relay tunnel connection; and
communicating the plurality of packets between the relay station and its adjacent relay station using the relay tunnel connection.

2. The method of claim 1, in which the relay tunnel connection is a unidirectional logical connection established on a per link basis, originating from one end of the wireless link and terminated at the other.

3. The method of claim 1, in which the relay tunnel connection contains one or multiple MAC connections to the mobile stations.

4. The method of claim 1, in which the relay tunnel connection contains one or multiple MAC connections originated from the relay station from which the relay tunnel connection originates.

5. The method of claim 1, in which the relay tunnel connection contains one or multiple MAC connections originated from the base station from which the relay tunnel connection originates.

6. The method of claim 1, in which a relay tunnel MAC PDU can be constructed by concatenating MAC PDUs that belong to the individual constituent MAC connection.

7. The method of claim 1, in which a relay tunnel MAC PDU can be constructed by appending a relay MAC header in front of the concatenated MAC PDUs that belong to the individual constituent MAC connection.

7. The method of claim 1, in which a relay tunnel MAC PDU is constructed by appending a relay tunnel MAC header in front of the concatenated MAC PDUs and inserting a PDU sequence number (SN) extended subheader immediately after the relay tunnel MAC.
